(19) United States
(12) Patent Application Publication
(10) Pub. No.: US 2026/0216981 A1
(43) Pub. Date: Jul. 30, 2026

(54) METHOD TO JOIN A SUPPORT FOR AN ELECTRONIC DEVICE TO A VULCANISED TYRE

(71) Applicant: Bridgestone Europe NV/SA, Zaventem (BE)

(72) Inventors: Francesco IOZIA, Roma (IT); Beatrice MELLARA, Roma (IT)

(21) Appl. No.: 19/146,133

(22) PCT Filed: Jan. 8, 2024
(86) PCT No.: PCT/IB2024/050157

§ 371 Date: Jul. 7, 2025

(30) Foreign Application Priority Data
Jan. 9, 2023 (IT) 102023000000126

(51) Int. Cl. B29D 30/00

(52) U.S. Cl. CPC B29D 30/0061; B29D 2030/0083

(57) ABSTRACT

Method for joining a support for an electronic device to a vulcanized tyre. The support is provided with at least one at least partially green rubber component having a connection surface. The method comprises the steps of: applying the support to a wall of the tyre placing the connection surface(S) of the support in direct contact with the wall of the tyre; and pre-heating the support in such a way that at the moment of applying the support to the wall of the tyre the connection surface(S) of the support has a temperature that is greater than the temperature of the vulcanized tyre.

### CROSS-REFERENCE TO RELATED APPLICATION

This application is a U.S. national stage filing under 35 U.S.C. § 371 of International Patent Application No. PCT/IB2024/050157, filed Jan. 8, 2024, which international application is incorporated herein by reference.

### FIELD OF THE INVENTION

The present invention refers to a method for joining a support for an electronic device (in particular a transponder) to a vulcanized tyre.

### BACKGROUND

In recent years, so-called “smart” pneumatic tyres have emerged, which are capable of forming an active part of modern vehicles, supplying information concerning the type of pneumatic tyres mounted, information concerning the state of the pneumatic tyres and also information concerning ambient conditions.

A “smart” tyre is normally equipped with a transponder (i.e. an electronic device with storage that is suitable for communicating in radio frequency) which permits remote communication (i.e. to both the vehicle whereupon the tyre is mounted and to an operator who must carry out the checking or the replacement of the tyre, or to external monitoring systems such as gates) the identification, the characteristics and history of the tyre.

Recently, the integration has also been proposed of RFID (“Radio-Frequency Identification”) transponder technology with the presence of a transponder or sensors operating using TPMS (“Tyre Pressure Monitoring Systems”) technology, which allows sensors to measure the inflation pressure and/or the effective internal temperature and then store such measurements in the transponder such as to be subsequently remotely communicated to receivers. Still more recently tyres are internally equipped with sensors or TPMS (“Tyre Pressure Monitoring Systems”) transponders that allow for the reading, processing, reception and transmission of characteristics regarding the state of the tyres such as accelerations, velocity, load, wear, road surface adhesion and so forth.

The need therefore has arisen to join an electronic device (transponder or sensor) to a tyre, and in order to implement this joining it is generally necessary to use a rubber support (housing) that is configured such as to accommodate therein (or house, or else only partially contain) the electronic device and to adhere it to the tyre in a stable and secure manner. According to one possible embodiment, the electronic device may be bonded in advance to the support (i.e. the bonding between the electronic device and the support is implemented before the support is inserted into the tyre) or else the electronic device may be bonded to the support only after having been inserted into the tyre.

In order to bond a support for an electronic device to a tyre, it is possible to attach the transponder to an inner surface of the tyre (typically above the innerliner that ensures the air tightness of the tyre), or else it is possible to integrate the support within the components that comprise the tyre structure (i.e., arrange the support in the middle of the various layers that comprise the tyre). Attaching the support to an inner surface of the tyre does not change the structure of the tyre in any way concerning the presence of foreign bodies and therefore ensures that the tyre may offer the expected performance. A support for an electronic device may be attached to the inner surface of the tyre when the tyre is still green (i.e., before vulcanizing the tyre) or else when the tyre has already been vulcanized.

During vulcanization, a layer of lubricant is generally applied which has the function of facilitating the detachment of the tyre from the vulcanization mold at the end of the vulcanization process; in particular, the lubricant is interposed between an inner surface of the tyre and an inner membrane (expansion bladder) of the vulcanization mold. Consequently, at the end of the vulcanization process, the inner surface of the vulcanized tyre has a layer of lubricant which must be locally removed (for example by cleaning using a laser beam, or else using special solvents, or by partial abrasion of the surface, or other available methods and techniques) within the area where the support is applied (otherwise the support may not be able to adhere with adequate force to the tyre surface). Consequently, attaching the support to the inner surface of the tyre when the tyre has already been vulcanized generally requires additional processing (cleaning the area where the support is applied) which increases production times and costs. Alternatively, the inner membrane (expansion bladder) of the mold may consist of particular materials, preferably silicone, which contribute to the detachment of the tyre without using any additional lubricant (release material); however, with the current state of technology, such inner membranes are relatively uncommon.

Furthermore, to ensure adequate adhesion of the support to the surface of the vulcanized tyre, it is necessary to use an adhesive (glue) that is sufficiently strong and compatible with the rubber compound that comprises the innerliner of the tyre, and that does not in any way damage the integrity of the innerliner of the tyre; this adhesive constitutes an additional cost in economic and environmental terms.

It would therefore be preferable, in order to reduce production lead times and costs, to attach the support for an electronic device to the inner surface of the tyre when the tyre is still green (i.e., before vulcanizing the tyre). It has, however, been observed that the high pressure and high temperature reached during the vulcanization process may cause parts of the electronic device (previously bonded to the support) to emerge outside the support thereof (the so-called “surfacing” phenomenon), often causing a malfunction (if not the complete failure) of the electronic device. In addition, the high pressure and high temperature reached during the vulcanization process may bring parts of the support or electronic device (previously bonded to the support) into contact with the carcass cords, thereby often causing a malfunction (if not the complete failure) of the electronic device and as a further consequence, this may negatively interfere with the operation of the carcass cords. Finally, the high pressure and high temperature reached during the vulcanization process may cause irregularities in the innerliner (particularly at the edge of the support) that in the long run may cause cracks in the innerliner, to the detriment of retention of the air inside the tyre with consequent pressure losses.

In the case wherein the support is initially empty (i.e. not initially containing an electronic device to be subsequently inserted into the support), it has further been observed that complicated and costly production processes are necessary in order to maintain the required shape and elasticity of the support such as to ensure the subsequent trouble-free insertion of the electronic device into the support.

The patent application WO2021126199A1 describes the insertion of an electronic sensor that has previously been bonded to a rubber support inside a tyre during the vulcanization of the tyre within a vulcanization mold.

The patent application WO2011040921A1 describes an electronic patch comprising a vulcanized rubber support whereupon an electronic device is mounted; the electronic patch is attached to a wall of a vulcanized tyre by means of the interposing of an adhesive green rubber layer that is applied to an inner wall of the electronic patch and initially covered with a removable protective film.

The patent application EP3168068A1 describes the application of an electronic patch (comprising a vulcanized rubber support whereupon an electronic device is mounted) to an inner wall of a vulcanized tyre by means of the interposing of an adhesive layer.

The patent application WO2017105842A1 describes an assembly for mounting an electronics package to a tyre; an electronics package attachment patch is permanently attached to the innerliner of the tyre by means of an adhesive or by means of a cold polymerization process.

### DESCRIPTION OF THE INVENTION

The object of the present invention is to provide a method for joining a support for an electronic device to a vulcanized tyre that makes it possible to avoid damage to the tyre, to the support and to the electronic device and that is at the same time easy and economical to implement with a view to reduced energy consumption and therefore more sustainable.

According to the present invention, a method for joining a support for an electronic device to a vulcanized tyre is provided, as set forth in the annexed claims.

The claims describe preferred embodiments of the present invention that form an integral part of the present description.

### BRIEF DESCRIPTION OF THE DRAWINGS

The present invention will now be described with reference to the attached drawings, which illustrate an exemplary, non-limiting embodiment, wherein:

FIG. 1 is a schematic cross-sectional view of a tyre provided with an electronic device;

FIGS. 2 and 3 are a perspective view and an exploded perspective view, respectively, of the electronic device of FIG. 1 inserted into a rubber support;

FIGS. 4, 6 and 7 schematically show some processing stations of a production plant which manufactures the tyre of FIG. 1;

FIG. 5 is a schematic view of a gripper used in the production plant;

FIG. 8 is a schematic view of a tool used in an application station of the production plant;

FIGS. 9 and 10 are a perspective view and a cross-sectional view, respectively, of a different embodiment of a rubber support that is suitable for containing an electronic device; and

FIG. 11 is a graph that shows the variation, obtained experimentally, of a force of adhesion to a wall of a vulcanized tyre of a support bonded to a transponder as the surface temperature of the wall varies.

### PREFERRED EMBODIMENTS OF THE INVENTION

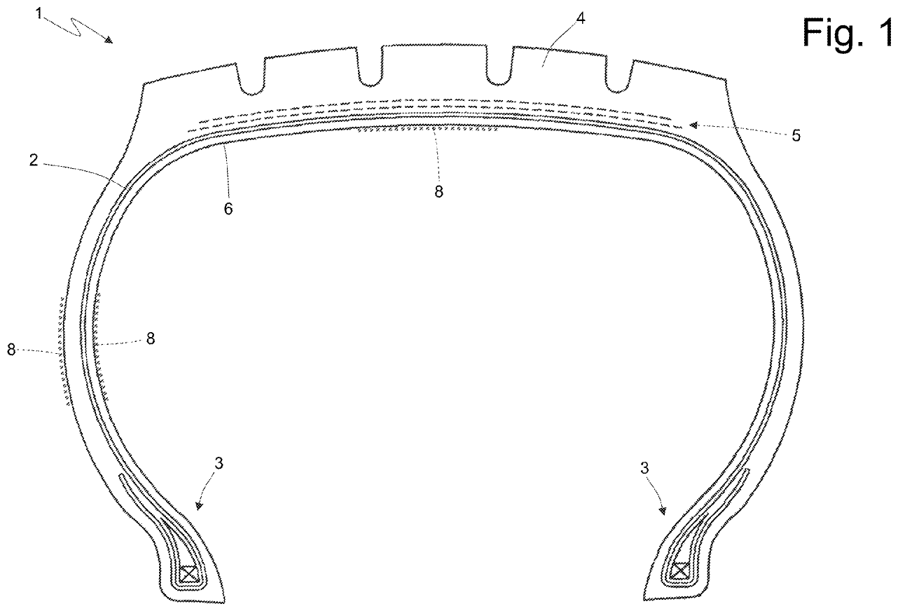

In FIG. 1, reference numeral 1 indicates as a whole a tyre 1 comprising a toroidal carcass 2, which is partially folded onto itself and therefore has two lateral flaps (i.e., two layers superimposed on one another and jointly referred to as “turn-up”). Two annular beads 3 are provided at opposite sides of the carcass 2, wherein each thereof is surrounded by the carcass 2. The carcass 2 supports an annular tread 4 with the interposing of a tread belt 5 and a pair of sidewalls that join the beads 3 to the tread 4. Arranged within the carcass 2 is an innerliner 6 which is airtight, constitutes an inner lining and has the function of retaining the air within the tyre 1 in order to maintain the inflation pressure of the same tyre 1 over time.

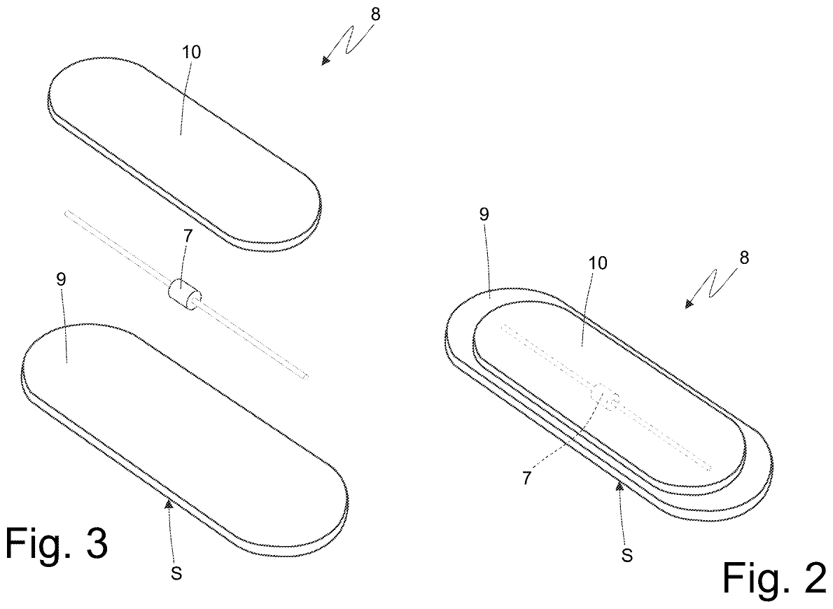

The tyre 1 is provided with a transponder 7 (shown in FIGS. 2 and 3) that is inserted into a support 8 and arranged in contact with a wall of the tyre 1; i.e. the support 8 is suitable for (conforms for) accommodating and retaining the transponder 7. As will be better explained hereafter, the transponder 7 may be bonded to the support 8 before applying the support 8 to the tyre 1, or else it may be bonded to the support 8 after having been applied to the support 8 of the tyre 1. As shown in FIG. 1, the transponder 7 inserted into the support 8 may indifferently be arranged within the tyre 1 (i.e. in contact with the innerliner 6) or else on the outside of the tyre 1 (i.e. from the side opposite the innerliner 6) and may indifferently be arranged at a sidewall (either on the inside or the outside of the tyre 1) or else at the tread 4 (only on the inside of the tyre 1).

The transponder 7 is an electronic device (normally passive or semi-passive, i.e. devoid of an electrical power supply thereof) that is capable of storing information and that is capable of communicating by means of radio frequency. In other words, the transponder 7 is a “smart label” of small dimensions that is suitable for responding to remote polling on the part of specific fixed or portable devices, called readers (or polling devices); a reader is capable of reading and/or modifying the information contained within the transponder 7 that is being polled whilst communicating with the transponder 7 itself in radio frequency. Accordingly, the transponder 7 is part of a wireless reading and/or writing system that operates according to so-called RFID technology (“Radio-Frequency IDentification”).

According to that shown in FIGS. 2 and 3, the transponder 7 is inserted into a support 8 consisting of two components 9 and 10 superimposed and pressed against each other: an inner component 9 which (as better described below) will be arranged in direct contact with one wall of the tyre 1 and an outer component 10 which (as better described below) will be arranged on the opposite side with respect to the wall of the tyre 1. Generally, the two components 9 and 10 of the support 8 are longer/wider than the transponder 7. Generally, the two components 9 and 10 are both made of rubber and are composed of exactly the same type of rubber compound; alternatively, the two components 9 and 10 may both be made of rubber and be composed of two different types of rubber compound. According to a different embodiment, only the inner component 9 (i.e., in direct contact with the wall of the tyre 1) is made of rubber (at least partially green, as better explained below) whilst the outer component 10 (i.e., arranged on the opposite side with respect to the wall of the tyre 1) is made of a material (plastic) other than rubber.

According to an alternative embodiment, the support 8 may consist only of the component 9 (i.e., the outer component 10 may not be present).

Each component 9 or 10 of the support 8 may have a monolayer structure (i.e., it may consist of a single type of material forming a single homogeneous layer) or it may have a multilayer structure (i.e., it may consist of two or more superimposed materials that form two or more layers).

The inner component 9 of the support 8 has a connection surface S, which faces the wall of the tyre 1 (i.e., it will be in direct contact with the wall of the tyre 1) and is therefore arranged on the opposite side of the transponder 7. That is to say that the inner component 9 of the support 8 has a connection surface S which is to be in direct contact with the wall of the tyre 1 and is arranged on the opposite side of the transponder 7 and a surface opposite the connection surface S whereupon the transponder 7 is supported.

According to an alternative embodiment, the transponder 7 is supported on the connection surface S itself, which is to be in direct contact with one wall of the tyre 1. In this embodiment, the transponder 7 is found to be interposed between the connection surface S, and therefore the component 9, and the wall of the tyre 1.

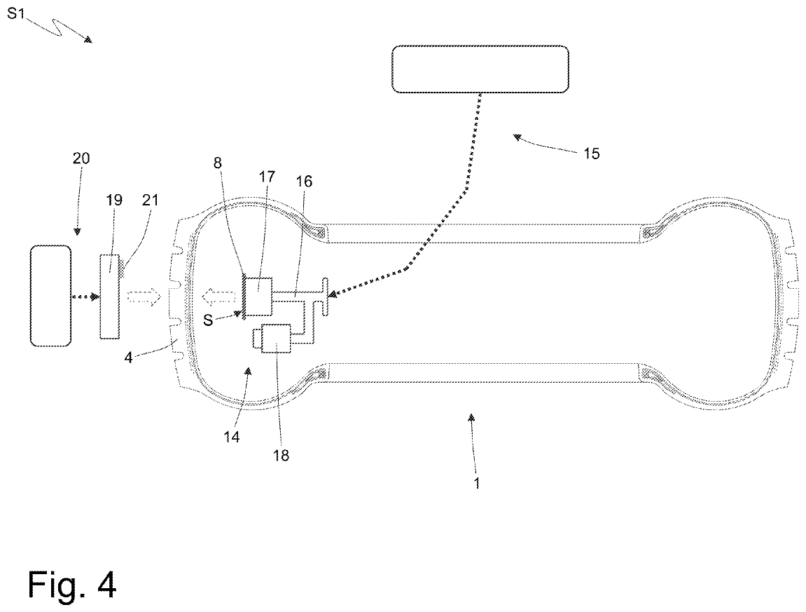

According to that shown in FIG. 4, the support 8 containing the transponder 7 is applied to one wall of the vulcanized tyre 1 (in particular to an inner wall of the vulcanized tyre 1 consisting of the innerliner 6 in the non-limiting exemplary embodiment shown in FIG. 4) placing the connection surface S of the component 9 of the support 8 in direct contact with the wall of the vulcanized tyre 1. That is to say that the support 8 containing the transponder 7 is applied to one wall of the tyre 1 after the tyre 1 has been extracted from a vulcanization mold and has therefore terminated the construction cycle thereof.

At least the component 9 of the support 8, bonded to the transponder 7, is previously heated before being applied to the wall of the tyre 1 in such a way that at the moment of applying the support 8 to the wall of the tyre 1 the connection surface S of the component 9 of the support 8 has a temperature that is greater than the temperature (substantially ambient, as better described below) of the wall of the vulcanized tyre 1.

According to a preferred embodiment, at the moment of applying the support 8 to the wall of the tyre 1 the connection surface S of the support 8 has a temperature of about 100° C. In particular, at the moment of applying the support 8 to the wall of the tyre 1 the connection surface S of the support 8 has a temperature of between 90° C. and 110° C. and preferably equal to about 100° C. More generally, at the moment of applying the support 8 to the wall of the tyre 1 the connection surface S of the support 8 has a temperature that is greater than 80-90° C. and lower than 120-110° C.

According to a preferred embodiment, heating the support 8, bonded to the transponder 7 (obviously before applying the support 8, bonded to the transponder 7, to a wall of the vulcanized tyre 1) provides for obtaining (implementing) vulcanization that is more or less complete of the support 8 or at least of the component 9 of the support 8. To this end, immediately before applying the support 8, bonded to the transponder 7, to the wall of the vulcanized tyre 1, the support 8, bonded to the transponder 7, is heated in maintaining the support at an elevated temperature, for example between 90° C. and 110° C., preferably equal to about 100° C., for a relatively long period of time, for example between 15 and 25 minutes and preferably equal to 20 minutes. During the heating of the support 8, bonded to the transponder 7, the support 8 is only subjected to heat and is not subjected to any mechanical pressure.

Applying the support 8, bonded to the transponder 7, to a wall of the tyre 1 provides for pressing the support 8 against the wall of the tyre 1 such as to subject the support 8 to continuous mechanical pressure. In particular, after having applied the support 8, bonded to the transponder 7, to the wall of the tyre 1, mechanical pressure, which pushes the support 8 against the wall of the tyre 1, is applied to the support 8 and maintained. According to a preferred embodiment, the mechanical pressure applied to the support 8 is of between 5 and 15 bar and preferably equal to 10 bar and is maintained for a period of time of between 10 and 30 minutes, preferably equal to 20 minutes.

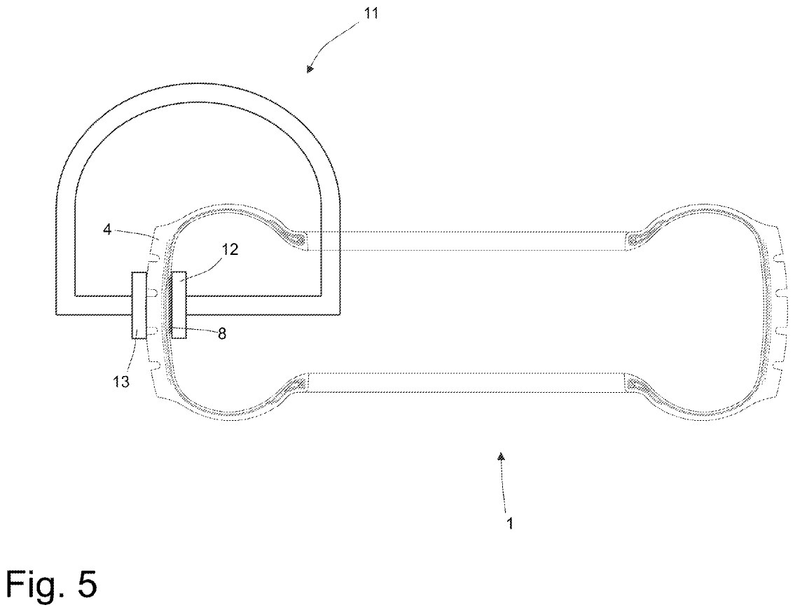

According to the embodiment shown in FIG. 5, the mechanical pressure is applied to the support 8, bonded to the transponder 7, by means of a ratchet gripper 11 provided with a jaw 12 that rests against the support 8 and an external jaw 13 that rests against the tyre 1 from the opposite side of the support 8. According to one possible embodiment, the jaw 12 is heated by means of a heating device that is configured such as to heat the support 8 applied to the wall of the tyre; the heater may maintain the support 8 at the initial application temperature (for example 100° C.) or else it may maintain the support 8 at a lower temperature than the initial application temperature (for example 70-80° C.).

The heat within the support 8, bonded to the transponder 7, at the moment of being applied to a wall of the vulcanized tyre 1 combined with the application of mechanical pressure to the support 8 leads to the successful completion of the vulcanization of the rubber present within the support 8 with the consequent optimal adhesion of the support 8, bonded to the transponder 7, to the wall of the vulcanized tyre 1, also without the interposing (use) of any adhesive or glue.

The support 8 (particularly the internal component 9 of the support 8) comprises, at least partially, green rubber that is subjected to vulcanization due to the effect of the pre-heating of the support 8 before being applied to a wall of the tyre 1 and due to the effect of the continuous mechanical pressure that is applied to the support 8 after the application thereof to the wall of the tyre 1. As previously stated, at least the inner component 9 of the support 8 consists of at least partially green rubber or of rubber which has not yet begun or in any case has not yet completed a vulcanization process; in other words, the inner component 9 has at least partially green rubber which constitutes the connection surface S (i.e., the surface in direct contact with the wall of the tyre 1). In particular, at least the rubber which constitutes the connection surface S of the inner component 9 (and which is therefore in direct contact with the wall of the tyre 1) has a lower degree of vulcanization than the rubber of the (possible) outer component 10 which is not in direct contact with the wall of the tyre 1; for example, the rubber of the inner component 9 is completely green and the rubber of the (possible) outer component 10 is partially vulcanized, or the rubber of both components 9 and 10 is partially vulcanized but has different degrees of vulcanization (a higher degree of vulcanization for the outer component 10 and a lower degree of vulcanization for the inner component 9).

Preferably but not necessarily, the inner component 9 is composed of completely green rubber, i.e., rubber that has never been vulcanized in any way, not even partially, or of only partially vulcanized rubber, i.e., rubber wherein the vulcanization has begun but has not been completed, i.e., rubber that is neither completely green nor completely vulcanized. Preferably but not necessarily, the outer component 10 (if present) is composed of only partially vulcanized rubber, i.e., rubber wherein the vulcanization has begun but has not been completed, i.e., rubber that is neither completely green nor completely vulcanized, or completely vulcanized rubber.

The connection surface S of the inner component 9 which is in direct contact with the innerliner 6 must ensure adhesion with the innerliner 6 and therefore must be less vulcanized (and therefore have a greater adhesion capacity) while the outer component 10 (if present) which covers the transponder 7 must guarantee the protection of the transponder and therefore must be able to have a higher degree of vulcanization (and therefore be harder and more resistant, also to the detriment of the adhesion capacity).

According to a preferred embodiment, the support 8, bonded to the transponder 7, is applied to one wall of the vulcanized tyre 1 when the vulcanized tyre 1 is found to be substantially at ambient temperature (of a tyre production plant or at a facility for replacing and fitting tyres wherein operators permanently work and therefore at a temperature that is generally of between 15 and 30° C.). That is to say, the support 8, bonded to the transponder 7, is applied to one wall of the tyre 1 when the surface temperature of the wall of the vulcanized tyre 1 is lower than 40° C. In particular, the support 8, bonded to the transponder 7, is applied to one wall of the tyre 1 when the surface temperature of the wall of the vulcanized tyre 1 is between 0° C. and 30° C. and preferably between 5° C. e 25° C.

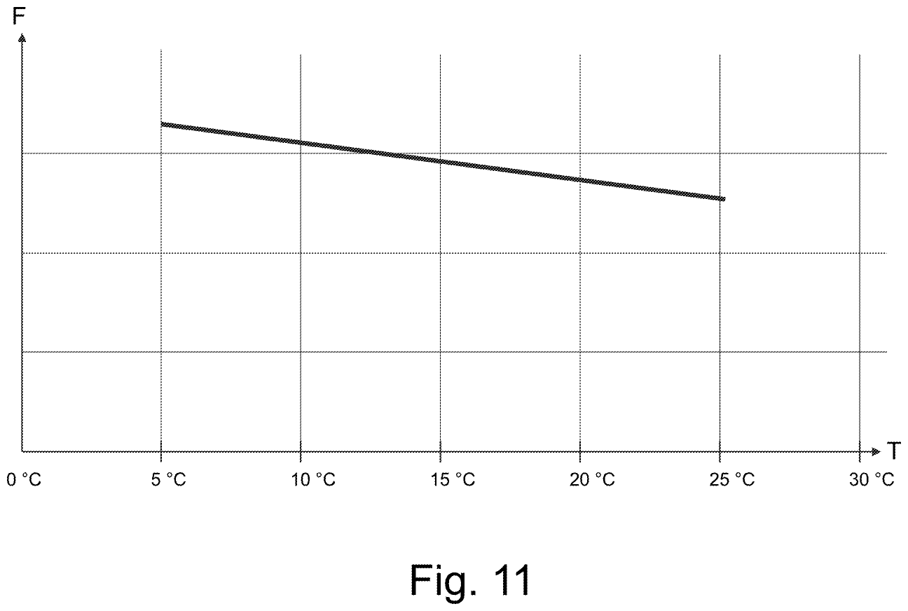

Experimental tests were conducted during which a support 8 (already bonded to the transponder 7, or else not bonded to the transponder 7) and pre-heated to about 100° C. is applied to one wall of a vulcanized tyre 1 which was found to be at various temperatures between a minimum of 5° C. and a maximum of 25° C. with intervals of 5° C.; the result of these experimental tests are shown in the graph of FIG. 11 wherein the x-axis reports the surface temperature T of the wall of the vulcanized tyre 1 and the y-axis reports the force F of adhesion to the tyre 1 of the component 9 of the support 8. That is to say, FIG. 11 is a graph that shows the variation, obtained experimentally, of the force F of adhesion to a wall of a vulcanized tyre 1 of a support 8 as the surface temperature of the wall varies. During all of the experimental tests (i.e. of the surface temperature of the wall of the vulcanized tyre 1 between 5° C. and 25° C.), the force F of adhesion of the component 9 of the support 8 to the wall of the vulcanized tyre 1 remained fairly constant and nonetheless always greater than an optimal value (i.e. a value sufficient to ensure complete and lasting adhesion of the support 8). It is therefore highly probable that the force of adhesion of the support 8 to the wall of the vulcanized tyre 1 is adequate, even if the surface temperature of the wall of the vulcanized tyre 1 is a little less than 5° C. (for example equal to 0° C.) or a little higher than 25° C. (for example equal to 30-35° C.).

In this regard, it has been observed that the force of adhesion that develops between the support 8 (bonded or not yet bonded to the transponder 7) and the wall of the vulcanized tyre 1 is surprisingly higher (all conditions being equal) when the vulcanized tyre 1 is “cold” (i.e. at environmental temperature) compared to when the vulcanized tyre 1 is “hot” (for example when is has just been extracted from the vulcanization mold). One possible motivation is tied to the fact that when the rubber that constitutes the vulcanized tyre 1 is hot there is an emergence of oils which, being interposed between the wall of the vulcanized tyre 1 and the support 8, obstruct the adhesion of the support 8; these oils which emerged when the tyre 1 is hot, are reabsorbed into the rubber that constitutes the vulcanized tyre 1 as the vulcanized tyre 1 cools and therefore the vulcanized tyre 1 at environmental temperature substantially lends itself better to fostering the adhesion of the support 8.

According to that shown in FIG. 4, an applicator device 14 applies the support 8 containing the transponder 7 to the wall of the vulcanized tyre 1. The applicator device 14 is moved by the robotic arm 15 (or by a similar handling device), i.e., the applicator device 14 is mounted at one end of the robotic arm 15. Preferably, the applicator device 14 comprises a frame 16 which is rigidly constrained to the robotic arm 15 and supports both an application head 17 which is configured to pick up the support 8 and to transfer the support 8 to the wall of the vulcanized tyre 1, and a camera 18 which frames the space in front of the application head 17 and is used for guiding the movements of the robotic arm 15.

According to one preferred embodiment shown in FIG. 4, when the support 8, bonded to the transponder 7, is applied to the wall of the tyre 1 a counter element 19 is arranged against one side of the wall of the tyre 1 opposite the side whereto the support 8 is applied. In the embodiment shown in FIG. 4, a counter element 19 is provided in the application station S1, which counter element is moved by an actuator device 20, is arranged outside the tyre 1 and is located at the applicator device 14. In particular, the counter element 19 is arranged, when the support 8, containing the transponder 7, is applied to the wall of the tyre 1, against the tyre 1 on the opposite side to where the support 8, containing the transponder 7, is applied. In this way, the applicator device 14 may forcefully press the support 8, containing the transponder 7, against the wall of the tyre 1 in so far as the thrust exerted by the applicator device 14 is adequately opposed by the counter element 19 without causing unwanted deformations of the tyre 1. In particular, the actuator device 20 presses (with a certain predetermined force) the counter element 19 against the outside of the vulcanized tyre 1 when, from the opposite side, the applicator device 14 applies the support 8 containing the transponders 7 to the wall of the vulcanized tyre 1. Depending upon the positioning of the transponder 7, the counter element 19 may press against the tread 4 of the tyre 1 or against a sidewall (side) of the tyre 1 (internally or externally).

According to a possible embodiment, one surface of the counter element 19, which comes into contact with the outside of the vulcanized tyre 1, bears a (small) relief pattern 21 (an inscription and/or a logo) which indicates the presence and the position of the transponder 7; preferably, the relief pattern 21 is heated to be able to better impress the relief pattern 21 onto the outside (tread 4 or sidewall) of the vulcanized tyre 1. The function of the relief pattern 21 imprinted on the outside (tread 4 or sidewall) of the vulcanized tyre 1 is to indicate from the outside the presence and position of the transponder 7.

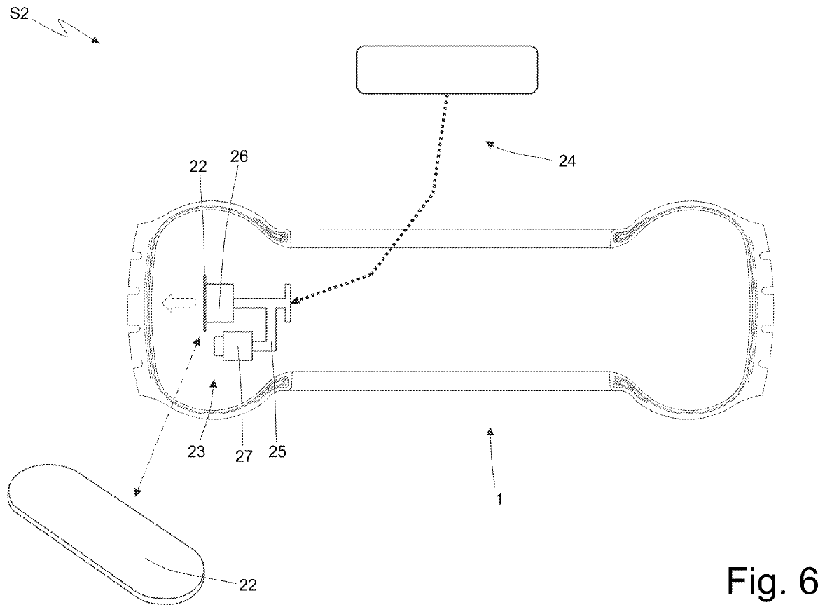

According to one possible embodiment shown in FIG. 6, a protective label 22 is applied to the wall of the green vulcanized tyre 1 at the area where the support 8, bonded to the transponder 7, is to be applied; the protective label 22 is then removed from the wall of the vulcanized tyre 1 after the extraction of the tyre 1 from the vulcanization mold and before applying the support 8, bonded to the transponder 7. The function of the protective label 22 is to protect (screen) the area of the wall of the tyre 1 where the support 8, bonded to the transponder 7, is to be applied, in such a way that such area remains devoid of a lubricant (for example silicone-based) which is used during the vulcanization and facilitates the detachment of the vulcanized tyre 1 from the vulcanization mold; in fact, the possible presence of residual lubricant between the wall of the vulcanized tyre 1 and the support 8, bonded to the transponder 7, would compromise the correct adhesion of the support 8 to the wall of the tyre 1. The lubricant may be applied with a lubrication station to an inner membrane (expansion bladder) of the vulcanization mold or else on the inner surface of the green tyre 1.

Obviously, the protective label 22 is only used when the support 8, bonded to the transponder 7, is to be applied to the inner surface of the vulcanized tyre 1, insofar as the lubricant is present during vulcanization only on the inner surface of the vulcanized tyre 1. Conversely, when the support 8, bonded to the transponder 7, is to be applied to the outer surface of the vulcanized tyre 1 (at the sidewalls), the protective label 22 is not necessary.

A different embodiment is also provided that does not provide for the use of the protective label 22 insofar as the lubricant is not applied before vulcanization, insofar as the formulation of the lubricant does not obstruct the correct adhesion of the support 8 to the wall of the tyre 1, or insofar as the area of the wall of the tyre 1 where the support 8 is to be applied is pre-cleaned before applying the support 8 such as to eliminate the residual lubricant.

Preferably, the protective label 22 is made of polyethylene terephthalate (also known commercially by the name of Mylar). Furthermore, the protective label 22 is preferably larger than the support 8 containing the transponder 7 in such a way as to be able to “compensate” with its larger size for the positioning tolerances (i.e., errors) (both in the positioning of the protective label 22, and in the positioning of the support 8 containing the transponder 7).

According to that shown in FIG. 6, in a station S2 arranged upstream of a vulcanization station (and obviously also upstream of a possible lubrication station wherein the lubricant is sprayed over the entire inner surface of the green tyre 1), an applicator device 23 (similar to the applicator device 14) is moved by a robotic arm 24 (or by a similar handling device) in order to apply the protective label 22 to one wall of the green tyre 1. Preferably, the applicator device 23 comprises a frame 25 which is rigidly constrained to the robotic arm 24 and supports both an application head 26 which is configured to pick up the protective label 22 and to transfer the protective label 22 to the wall of the green tyre 1, and a camera 27 which frames the space in front of the application head 26 and is used for guiding the movements of the robotic arm 24.

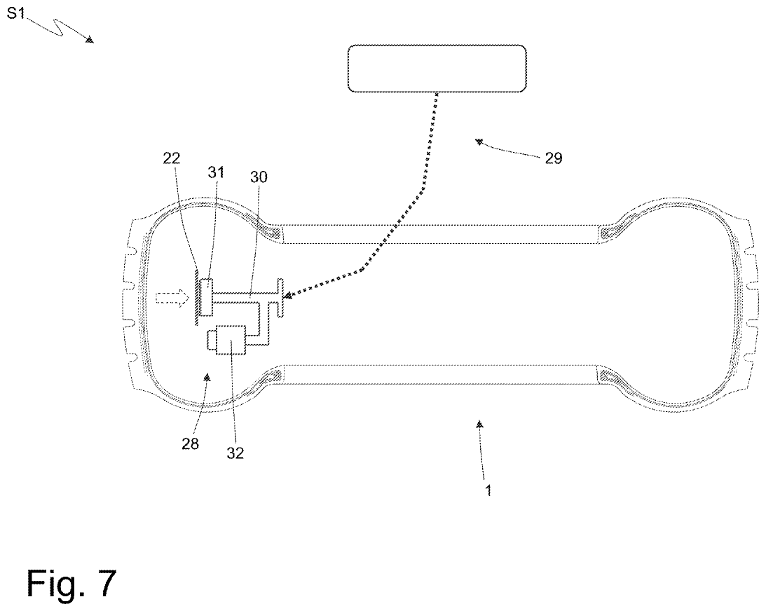

At the end of the vulcanization process, the vulcanized tyre 1 is extracted from the vulcanization mold and left to cool (for many hours or days) until finally reaching a substantially environmental temperature. According to that shown in FIG. 7 and in the application station S1, the protective label 22 is initially removed from the wall of the vulcanized tyre 1 by means of a removal device 28 so as to reveal the underlying portion of the wall of the vulcanized tyre 1 which is completely devoid of the lubricant (obviously only in the case wherein the protective label 22 has been previously applied).

The removal device 28 is moved by a robotic arm 29 (or by a similar handling device), i.e., the removal device 28 is mounted at one end of the robotic arm 29. Preferably, the removal device 28 comprises a frame 30 which is rigidly constrained to the robotic arm 29 and supports both a pick-up head 31 which is configured to remove the protective label 22 from the wall of the vulcanized tyre 1, and a camera 32 which frames the space in front of the pick-up head 31 and is used for guiding the movements of the robotic arm 29.

According to one possible embodiment, within the application station S1 there are two different robotic arms 15 and 29 that move, respectively, the applicator device 14 and the removal device 28. Alternatively, a single robotic arm 15 or 29 may be present that alternately moves the applicator device 14 and the removal device 28, i.e. a single robotic arm 15 or 29 first moves the removal device 28 to remove the protective label 22 from the wall of the vulcanized tyre 1 and immediately afterwards exchanges the removal device 28 with the applicator device 14 (i.e., releases the removal device 28 and then withdraws the applicator device 14) in order to apply the support 8 to the wall of the vulcanized tyre 1.

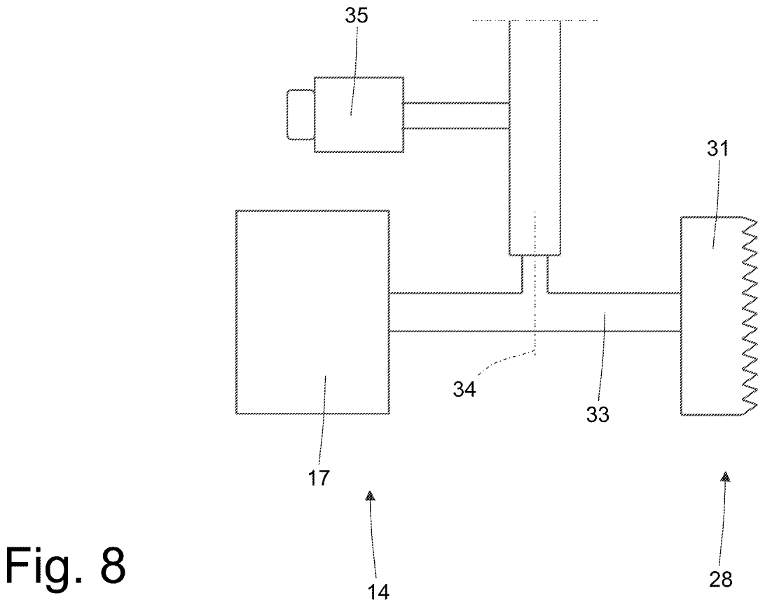

According to a further embodiment illustrated in FIG. 8, the applicator device 14 which applies the support 8 containing the transponder 7 to a wall of the vulcanized tyre 1 and the removal device 28 which removes the protective label 22 from the wall of the vulcanized tyre 1 are supported together (simultaneously) by a same robotic arm 15 or 29; in particular, the applicator device 14 and the removal device 28 are mounted on the robotic arm 15 by means of a rotatable support element 33 which is rotated about an axis of rotation 34 to alternately arrange the applicator device 14 or the removal device 28 towards the wall of the vulcanized tyre 1. In this embodiment, a single camera 35 may be provided which does not rotate (i.e., is not connected to the support element 33), is common for both devices 14 and 28, and therefore replaces the cameras 18 and 32.

As previously stated and according to a different embodiment, it is possible to spray, before inserting the green tyre 1 into the vulcanization mold, on the inner surface of the green tyre 1 or on the inner membrane (expansion bladder) of the vulcanization mold, a lubricant which does not hinder the adhesion of the support 8 containing the transponder 7 to the innerliner 6; in this embodiment, the presence of the protective label 22 (and therefore of the applicator device 23 and of the removal device 28) is no longer necessary, insofar as the lubricant does not hinder the adhesion of the support 8 containing the transponder 7 to the wall of the vulcanized tyre 1.

As previously stated and according to a further embodiment, no lubricant is applied to the inner surface of the green tyre 1 or to the inner membrane (expansion bladder) of the vulcanization mold, since the inner membrane (expansion bladder) of the vulcanization mold has a low adhesion surface which does not require the presence of the lubricant; obviously in the absence of the lubricant, the presence of the protective label 22 (and therefore of the applicator device 23 and of the removal device 28) is no longer necessary.

As previously stated and according to a further embodiment, the protective label 22 is not applied and the removal device 28 is replaced by a cleaning device which cleans (for example by means of a laser) the area of the wall of the vulcanized tyre 1 whereto the support 8 containing the transponder 7 is to be applied.

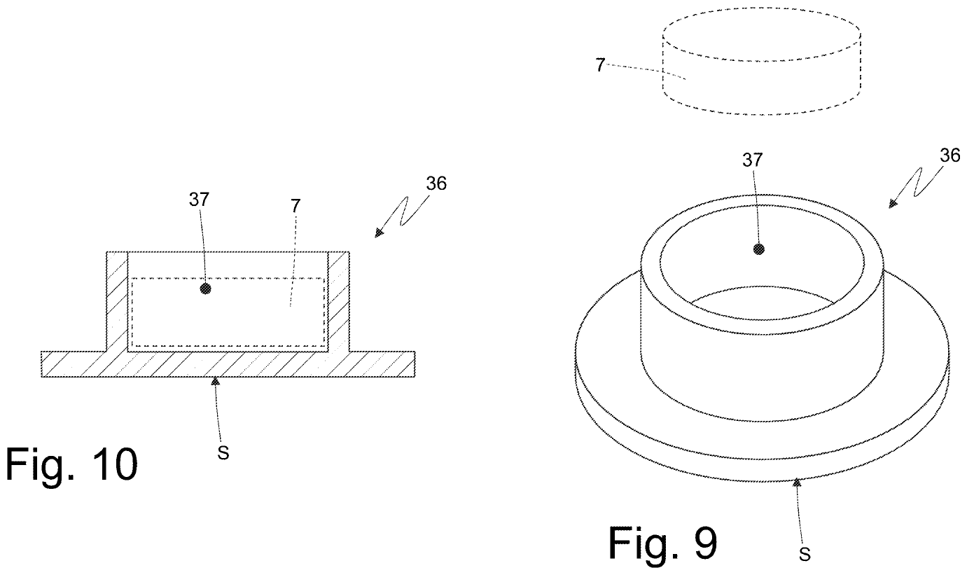

In the embodiment shown in FIGS. 1-8, the support 8 is pre-bonded to the respective transponder 7 (i.e. to the respective electronic device) in such a way that the support 8, already containing the respective transponder 7, is joined to the tyre 1 (using the joining method described above); in the embodiment shown in FIGS. 1-8, the support 8 surrounds, on all sides, the respective transponder 7 (i.e. the respective electronic device) such to offer greater protection to the respective transponder 7. The embodiment shown in FIGS. 9 and 10 instead provides for a support 36 that, centrally, is provided with a seat 37 generally conforming to a cup to house and retain the respective transponder 7 (i.e. the respective electronic device); in this embodiment, the support 36 is joined to the tyre 1 (using the joining method described above) devoid of the respective transponder 7 (i.e. the respective electronic device) which is inserted in the seat 37 of the support 36 only subsequently (i.e. only after the support 36 has been joined to the tyre 1). The support 36 may comprise a single component (corresponding to the component 9 of the support 8) or else it may consist of several components bonded together.

Summarizing the above, the support 8 or 36 is for one electronic device 7 (i.e. it is suitable/formed for housing and retaining an electronic device 7) and is joined to a tyre 1 to enable the electronic device 7 to be integrated into the tyre 1; as previously stated, the transponder 7 may be bonded to the support 8 or 36 before applying the support 8 or 36 to the tyre 1, or else it may be bonded to the support 8 or 36 after having applied the support 8 or 36 to the support of the tyre 1.

The method described above has many advantages.

Firstly, the method described above is particularly simple and inexpensive to implement insofar as it provides for the execution of few operations which are easily automated and insofar as it requires minimal energy consumption (the overall mass of the support 8 containing the transponder 7 is very small and therefore the heating, at about 100° C., of the support 8 containing the transponder 7, requires almost negligible thermal energy, when compared, for example, to the thermal energy required for the vulcanization of the tyre 1). The method described above is therefore considered sustainable in being environmentally friendly in the production of smart tyres.

The method described above allows damage to the tyre 1 and to the transponder 7 to be prevented.

The method described above does not require the use of any adhesive to attach the support 8 containing the transponder 7 to the wall of the vulcanized tyre 1, insofar as only the force of adhesion that is established between two rubber layers subjected to pressure at a certain temperature is used to make the support 8 adhere to the innerliner 6; in this way, both the cost and the environmental impact are reduced.

Finally, the method described above ensures adequately strong and resistant adhesion of the transponder 7 to the tyre 1, thereby avoiding the risk that the transponder 7 may detach itself, even partially, from the tyre 1.

List of reference numbers in the figures

| | |
|---|---|
| 1 | pneumatic tyre |
| 2 | carcass |
| 3 | beads |
| 4 | tread |
| 5 | tread belt |
| 6 | innerliner |
| 7 | transponder |
| 8 | sleeve |
| 9 | strip |
| 10 | strip |
| 11 | gripper |
| 12 | internal jaw |
| 13 | external jaw |
| 14 | applicator device |
| 15 | robotic arm |
| 16 | frame |
| 17 | application head |
| 18 | camera |
| 19 | counter element |
| 20 | actuator device |
| 21 | relief pattern |
| 22 | protective label |
| 23 | applicator device |
| 24 | robotic arm |
| 25 | frame |
| 26 | application head |
| 27 | camera |
| 28 | removal device |
| 29 | robotic arm |
| 30 | frame |
| 31 | removal head |
| 32 | camera |
| 33 | support element |
| 34 | axis of rotation |
| 35 | camera |
| 36 | support |
| 37 | seat |
| S | connection surface |
| S1 | application station |
| S2 | application station |

1-20. (canceled)

21. A method for joining a support for an electronics device to a vulcanized tyre; the support is provided with at least one partially green rubber component having a connection surface;
the method comprises the steps of:
applying to one wall of the vulcanized tyre the support placing the connection surface of the support in direct contact with the wall of the tyre; and
pre-heating the support before applying the support to the wall of the tyre in such a way that at the moment of applying the support to the wall of the tyre the connection surface of the support has a temperature that is greater than the temperature of the vulcanized tyre.

22. The method according to claim 21, wherein at the moment of applying the support to the wall of the tyre the connection surface of the support has a temperature that is greater than 80° C.

23. The method according to claim 21, wherein at the moment of applying the support to the wall of the tyre the connection surface of the support has a temperature that is between 90° C. and 110° C.

24. The method according to claim 21, wherein the step of pre-heating the support provides for the partial vulcanization of the support.

25. The method according to claim 21, wherein the step of pre-heating the support provides for maintaining the support at a temperature of between 90° C. and 110° C. for a period of time between 15 and 25 minutes.

26. The method according to claim 21, wherein the step of applying the support to the wall of the vulcanized tyre provides for pressing the support against the wall in order to subject the support to continuous mechanical pressure.

27. The method according claim 21 and comprising, after applying the support to the wall of the tyre, the further step of applying and maintaining mechanical pressure to the support which pushes the support against the wall of the tyre.

28. The method according to claim 27, wherein the mechanical pressure applied to the support is between 5 and 15 bars is maintained for a time interval of between 10 and 30 minutes.

29. The method according to claim 27, wherein the mechanical pressure is applied by means of a gripper, provided with a first jaw which is arranged against the support and a second jaw which is arranged against the tyre on the opposite side of the support.

30. The method according to claim 29, wherein the first jaw is heated by means of a heating device configured to heat the support applied to the wall of the tyre.

31. The method according to claim 21, wherein the support is applied to the wall of the tyre when the tyre is at ambient temperature.

32. The method according to claim 21, wherein the support is applied to the wall of the tyre when the surface temperature of the tyre is less than 40° C.

33. The method according to claim 21 and comprising the further step of, when the support is applied to the wall of the tyre, a counter element is applied to the wall of the tyre opposite the side whereto the support is applied.

34. The method according to claim 33, wherein a surface of the counter element which comes into contact with the wall of the tyre bears a relief pattern indicating the presence and the position of the electronic device.

35. The method according to claim 34, wherein the relief pattern of the counter element is heated.

36. The method according to claim 21 and comprising the further steps of:
applying a protective label to the wall of the green tyre at the area where the support is to be applied; and
removing the protective label from the wall of the vulcanized tyre before applying the support.

37. The method according to claim 21, wherein the support consists of an inner component and an outer component which enclose the electronic device therebetween.

38. The method according to claim 37, wherein the inner component, which is arranged in direct contact with the wall of the tyre and has the connection surface, consists of an at least partially green rubber.

39. The method according to claim 37, wherein the inner component, which is arranged in direct contact with the wall of the tyre and has the connection surface, consists of rubber which has a lower degree of vulcanization compared to the rubber constituting the outer component.

40. The method according to claim 21, wherein no adhesive or glue is interposed between the support and the wall of the vulcanized tyre.
